(19) United States
(12) Patent Application Publication
(10) Pub. No.: US 2011/0289070 A1
(43) Pub. Date: Nov. 24, 2011

(54) Dynamic resource orchestration system for data retrieval and output generation

(75) Inventors: Greg A. Wade, Shiloh, IL (US); Christopher W. Pate, O'Fallon, IL (US); Jason E. Lee, O'Fallon, IL (US)

(73) Assignee: LOCKHEED MARTIN CORPORATION, Bethesda, MD (US)

(21) Appl. No.: 12/801,077

(22) Filed: May 20, 2010

(51) Int. Cl. G06F 17/30

(52) U.S. Cl. 707/718; 707/E17.017; 707/E17.055

(57) ABSTRACT

A resource coordinating system is provided. The resource coordinating system has an interface module that receives a request from a user and an ontology framework module including a plurality of objects, each object being associated with a respective resource. The resource coordinating system also has a search module that coordinates a retrieval of information from one or more resources based on a search strategy generated in response to the user's request and an output module that generates an output to the user based on the retrieved information wherein, the search strategy selects objects from the ontology framework module based on the user's request and each selected object directs the search module to its associated resource.

### BACKGROUND

With the exploding size and complexity of the internet, it is becoming more difficult to retrieve desired information, especially if the information is stored across multiple archives. First, one has to navigate among millions of websites and databases to find the desired information. Without an automated tool, finding the desired information becomes an almost impossible task.

Several attempts have been made to find information scattered throughout the internet. Such attempts have led to web browsing, search engines, and other searching devices and methods. However, these solutions require manually mapping resources to each search permutation. In other words, each time a new resource is added to the search environment, each previously mapped resource must be manually mapped to the new resource and vice versa. This can be time consuming and labor intensive.

### SUMMARY

In a first embodiment, a resource coordinating system can include an interface module that receives a request from a user and an ontology framework module including a plurality of objects, each object being associated with a respective resource. The resource coordinating system can also include a search module that coordinates a retrieval of information from one or more resources based on a search strategy generated in response to the user's request and an output module that generates an output to the user based on the retrieved information wherein, the search strategy selects objects from the ontology framework module based on the user's request and each selected object directs the search module to its associated resource.

In another embodiment, a method for retrieving information in response to a request from a user can include receiving the request from the user and selecting a plurality of objects from an ontology framework based on the user's request. The method can also include accessing resources associated with the selected objects and retrieving data from the associated resources and generating an output in response to the retrieved data.

In another embodiment, a resource coordinating system can include an interface module that receives a request from a user and an request processor that formats the user's request to be in a form compatible with the resource coordinating system. The resource coordination system can also include an ontology framework module including a plurality of objects, each object being associated with a respective resource and a search module that coordinates a retrieval of information from one or more resources based on a search strategy generated in response to the user's request. The resource coordinating system can further include an output module that generates an output to the user based on the retrieved data, the output being at least one of a presentation of information, or a command to perform.

### BRIEF DESCRIPTION OF THE DRAWINGS

The features and nature of the present disclosure will become more apparent from the detailed description set forth below when taken in conjunction with the accompanying drawings in which reference characters identify corresponding items.

FIG. 1 illustrates an exemplary resource orchestration system;

FIG. 2 illustrates an exemplary search module of the resource orchestration system of FIG. 1;

FIG. 3 is a flow chart of an exemplary method for orchestrating resources to retrieve data and generate an output;

FIG. 4 is a flow chart of an exemplary method for performing the request inputting step of FIG. 3;

FIG. 5 is a flow chart of an exemplary method for performing the request processing step of FIG. 3;

FIG. 6 is a flow chart of an exemplary method for performing the search strategy generation and search execution step of FIG. 3;

FIG. 7 is a flow chart of an exemplary method for performing the output generation step of FIG. 3;

FIG. 8 illustrates an exemplary user request modified by a request processing device of the resource orchestration system of FIG. 1;

FIG. 9 illustrates exemplary key term groups for the exemplary user request of FIG. 8;

FIG. 10 illustrates a list of synonyms for one of the key terms of the exemplary user request of FIG. 8;

FIG. 11 illustrates an exemplary object chain extracted from the ontology framework of the exemplary search module of FIG. 2;

FIG. 12 illustrates the exemplary object chain of FIG. 11 with associated resources;

FIG. 13 illustrates another exemplary object chain extracted from the ontology framework of the exemplary search module of FIG. 2;

FIG. 14 illustrates the exemplary object chain of FIG. 13 with associated resources; and

FIG. 15 illustrates an output generated in response to the retrieved data and the user request.

### DETAILED DESCRIPTION OF EMBODIMENTS

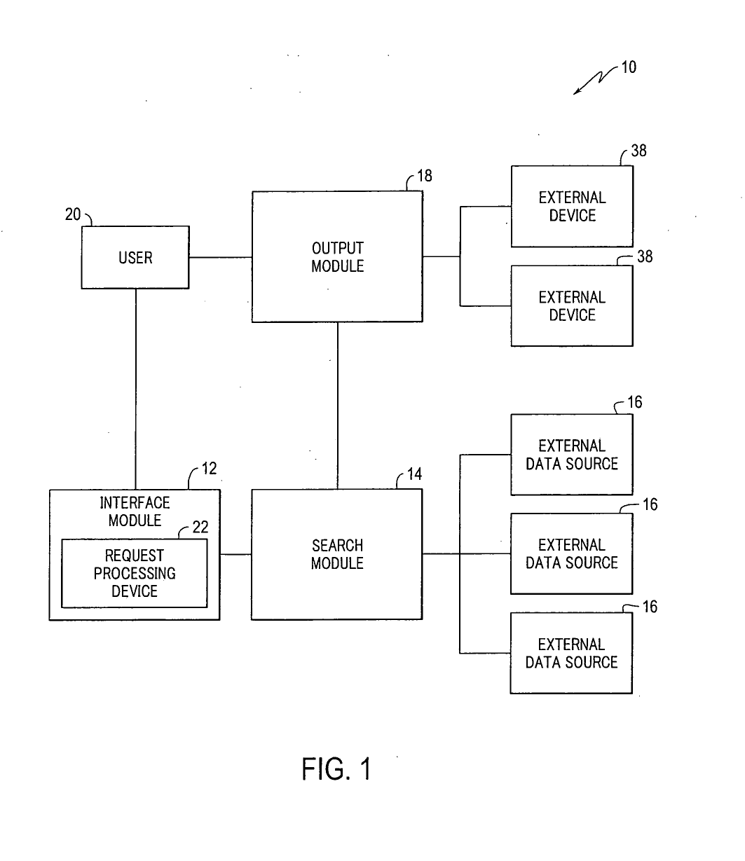

FIG. 1 illustrates an exemplary resource orchestration system (ROS) 10 that may be used to coordinate resources to retrieve information and generate an output based on the retrieved data. The resources may be, for example, web services, external ontology frameworks, semantic data sources, conventional databases or any system or apparatus that may store data or indicate a location where data may be found. The ROS 10 may be a self-contained, centrally located system or a decentralized network-type system. In addition, the ROS 10 may include an interface module 12, a search module 14, one or more external resources 16 and an output module 18.

The interface module 12 may be a device that receives one or more requests from a user 20. The user's requests may be for information retrieval and/or an output based on retrieved data. In addition, the user 20 may be a human or an automated device such as, for example, a controller for a device or system, a computer, a search engine, a web page or any other automated device requesting information. Furthermore, the interface module 12 may interface with the user 20 via any type of input device such as, for example, a keyboard, a display, a microphone, a speaker, a website, an instant messaging service, a direct network connection, etc. The interface module 12 may also include a request processing device 22 that may modify the user's request.

The request processing device 22 may be implemented when a format of the user's request is incompatible with the search module 14. The format may be incompatible when the search module 14 is unable to understand and fulfill the user's request. The request processing device 22 may be, for example, a natural language processor or any device capable of modifying the format of the user's request so that the search module 14 is able to understand and fulfill the user's request.

It is contemplated that the request processing device 22 may be omitted if the interface module 12 accepts only formats that are already compatible with the search module 14 without further refinement. Although the request processing device 22 is illustrated as being internal to the interface module 12, the request processing device 22 may be a device external to the interface module 12, if desired. It is also contemplated that the interface module 12 may be omitted, and the user 20 may directly input the user's request directly into the search module 14. If the interface module 12 is omitted, the request processing device 22 may be part of or directly connected to the search module 14.

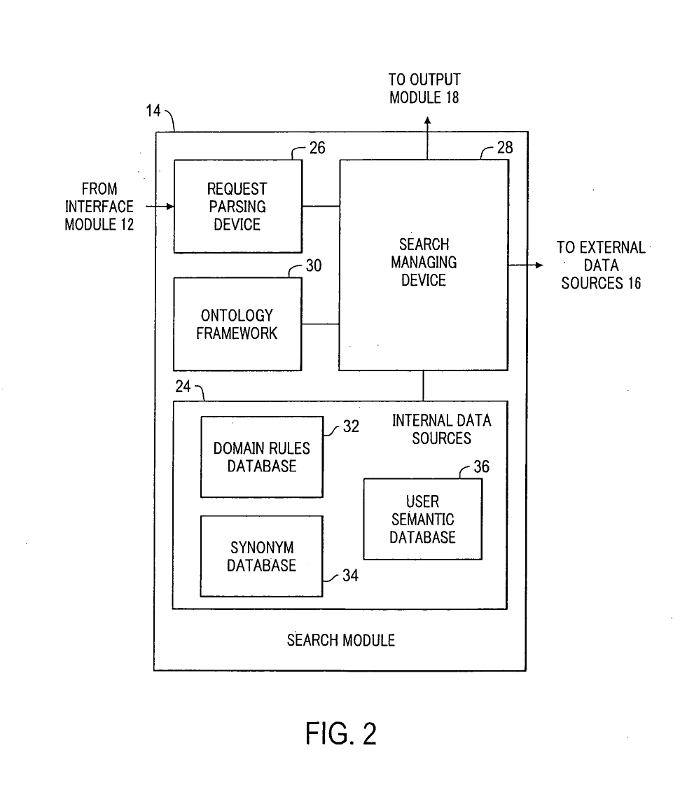

FIG. 2 illustrates an exemplary search module 14. The search module 14 may receive the user's request from the interface module 12 and may coordinate resources to retrieve information and fulfill the user's request. The coordinated resources may include the external resources 16 and internal resources 24 within the search module 14. To facilitate the retrieval of the information, the search module 14 may also include a request parsing device 26, a search managing device 28 and an ontology framework 30.

Some user requests may include terms that may be mere filler and may not aid in the search for the requested information. For example, in the request “Find the location of my stuff,” the terms “the” and “of” may serve no function other than mere filler and may not aid in the search for the requested information. Accordingly, the request parsing device 26 may be a device that may parse out key terms from the user's request. Such key terms may be the terms contained within the user's request that may be more than mere filler and may facilitate the retrieval of the requested information.

The request parsing device 26 may also substitute key terms in the user's request to facilitate the retrieval of information. The substitution of key terms may be based on the format of the user's request or any other factor. For example, the request parsing device 26 may know that requests in the form of a question beginning with the term “where” may be requesting a location. Therefore, the request parsing device 26 may substitute the term “where” in the user exemplary user request “Where is my stuff?” with the term “location.” In addition, the request parsing device 26 may substitute the term “when” in the exemplary user request “When will my stuff arrive in Buffalo?” with the term “time” because the request parsing device 26 may know that requests in the form of a question beginning with the term “when” may be requesting a time.

In order to fulfill the user's request, the search module 14 may need to retrieve intermediate information. For example, before fulfilling the request, “Where is my stuff,” the search module 14 may need to know what “my stuff” is. Thus, the request parsing device 26 may group the key terms to facilitate the retrieval of intermediate and the requested information. For the exemplary request, “Where is my stuff,” the request parsing device 26 may form a first key term group that may include “my” and “stuff” to facilitate the retrieval of intermediate information. In addition, the request parsing device 26 may form a second key term group that may include the terms “where” and “stuff” to facilitate the retrieval of the requested information once the intermediate information is retrieved.

The search managing device 28 may generate a search strategy and execute a search according to the search strategy to retrieve the desired information. To generate a search strategy, the search managing device 28 may extract an object chain from the ontology framework 30. Each object may be a thing or a concept (e.g., user ID, location) and may be associated with an external resource 16 or an internal resource 24. The object chain may form a foundation on which a search strategy may be built. Each link in the object chain may include two objects and a known relationship between the two objects. In addition, each link in the chain may direct the search managing device 28 to a resource and specific information stored in the resource.

As discussed above, the ontology framework 30 may include representations of relationships between objects. The objects may be associated with the external resources 16 or the internal resources 24. The relationships and objects populating the ontology framework 30 may be manually inputted or may be relationships identified in previous searches. The ontology framework 30 may be a single archive or multiple archives that may be interconnected. In addition, the ontology framework 30 may be contained within the search module 14 or may be external to the search module 14. For embodiments in which the ontology framework 30 includes multiple archives, some of the archives may be located within the search module 14, and some archives may be located outside of the search module 14.

The internal resources 24 may include a domain rules database 32, a synonym database 34 and a user semantic database 36. The domain rules database 32 may contain logistics domain codes that may be excluded from the ontology framework 30. The logistics domain codes may include, for example, transportation control numbers, national stock numbers, or any other alphanumeric code that may be used to identify and/or locate a resource. The synonym database 34 may be an archive of related words similar to a thesaurus and may be used to substitute terms within the user's request that are not in the ontology framework 30 with terms that are in the ontology framework 30. The user semantic database 36 may be an archive of information about the user 20. For example, the user semantic database 36 may include a user name, user passwords, the user's social security number, the user's URL address or any other information that may be used to identify or describe the user 20. It is contemplated that the information contained within the user semantic database 36 may be inputted by the user or a third party. It is further contemplated that the internal resources 24 may include additional resources such as, for example, semantic data sources, conventional databases, or any other system or apparatus that may store data or indicate a location where data may be found.

Referring back to FIG. 1, the external resources 16 may be, for example, web services, external ontology frameworks, semantic data sources, conventional databases or any system or apparatus that may store data or indicate a location where data may be found.

The output module 18 may be a device for generating an output based on the user's request and the information retrieved by the search module 14 and may be in communication with the user 20 and/or one or more external devices 38. Each external device 38 may be a logistic system, a controller, a computer network or any other device that may be capable of receiving information or commands from the output module 18. In addition, the output generated by the output module 18 may be a report of the results of a search for information or may be a command based on the results of the search for information. For example, the user 20 may submit a request, “Ship fifty shovels to each store location where it is forecasted to snow” and the search module 14 may retrieve information indicating that it is forecasted to snow in Buffalo, N.Y. The output module 18 may generate an output to an automated logistics network associated with a warehouse that may include a command to ship 50 shovels to stores located in Buffalo, N.Y.

The output module 18 may interface with the user 20 via the same types of devices through which the interface module 12 may interface with the user 20 or may use the same devices through which the interface module 12 may interface with the user 20. In addition, the output module 18 may be connected through communication lines or wirelessly to the external devices 38. It is contemplated that the output module 18 may be connected to only the user 20 or only the external devices 38 instead of being connected to both the user 20 and the external devices 38. It is further contemplated that in embodiments where only the search results are outputted, the output module 18 may be omitted, and the search results may be outputted to the user 20 and/or external devices 38 via the interface module 12 or the search module 14.

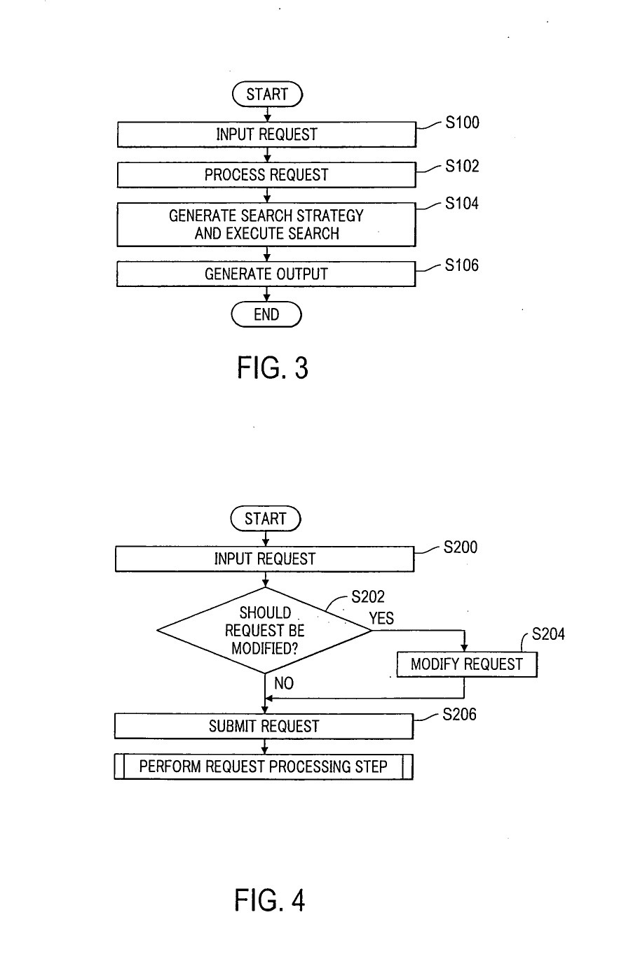

FIG. 3 illustrates an exemplary method for orchestrating resources to retrieve data and generate an output. The method may begin at step 100 when the user 20 inputs a request for information into the ROS 10. Next, at step 102, the user's request may be processed to facilitate the generation of a search strategy. At step 104, the ROS 10 may generate a search strategy and execute a search in accordance with the search strategy. Finally, at step 106, the ROS 10 may output the results of the search to the user 20 and/or the external devices 38 or may output a command to the external devices 38.

FIGS. 4-7 illustrate more detailed descriptions of each step of the method disclosed in FIG. 3. As illustrated in FIG. 4, a user 20 (human or automated device) may input a request into the interface module 12 (step 200). The user's request may be a request for information (e.g., Where is it snowing?) or a command (e.g., Ship 50 shovels to store locations where snow is in the weather forecast.) The interface module 12 may accept the user's request in any one of a variety of formats such as, for example, natural language (e.g., “Where is my stuff?”), a list of key terms (e.g., “user1234 property location”) or any other format capable of conveying the user's request. Alternatively, instead of accepting the user's request in any one of a variety of formats, the interface module 12 may accept the user's request only if it is in a predetermined format. In addition, the user 20 may input the request through any number of input devices such as, for example, a keyboard, a microphone, a website, an instant messaging service, direct network connection, etc. It is contemplated that the interface module 12 may be omitted, and the user 20 may input the request directly into the search module 14.

To process the user's request, the search module 14 may determine the role of each term in the user's request. For example, in the request “user1234 property location,” the first term may describe the second term; the second term may describe the third term; and the third term may be the focus of the request. However, for some request formats, it may be difficult for the search module 14 to determine the role of each term. For example, in the natural language format, the role of a particular term may vary depending on the request (e.g., the term “stuff” may be the focus of the request “What stuff is in the warehouse?” but may not be the focus of the request “Whose stuff is in the warehouse?”). Accordingly, those requests for which it may be difficult to determine the role of each term may be modified to facilitate processing the user's request.

At step 202, it may be determined whether to modify the user's request. The determination of whether or not to modify the user's request may be based on any number of factors. For example, the determination may be based on the type of request format (i.e., certain formats may always be modified, while other formats may not be modified). If it is determined that the request format is to be modified (step 202: yes), the user's request may be modified (step 204). However, if it is determined that the user's request may not be modified, the user's request may be submitted to the search module 14 in its original format (step 206).

Modifications to the user's request may be performed by the request processing device 22 so that the search module 14 may be able to determine the role of each term in the user's request. In particular, modifying the user's request may enable to search module 14 to determine the focus of the user's request. The request processing device 22 may be any device capable of facilitating determination of the role of each term in the user's request for information. For example, the request processing device 22 may be a natural language processor for modifying a request made in a natural language format. The natural language processor may aid the determination of the role of each term in the user's request by tagging each term in the request as a part of speech.

After the user's request is modified, the user's request may be submitted to the search module 14 (step 206). It is contemplated that for embodiments in which the ROS 10 accepts only one format, the step 202 may be omitted. In such embodiments, the user's request may either always be modified or may never be modified depending on the type of format accepted by the ROS 10. In addition, the interface module 12 may include the request processing device 22, or alternatively, the request processing device 22 may be a separate device outside of the interface module 12 and/or the ROS 10.

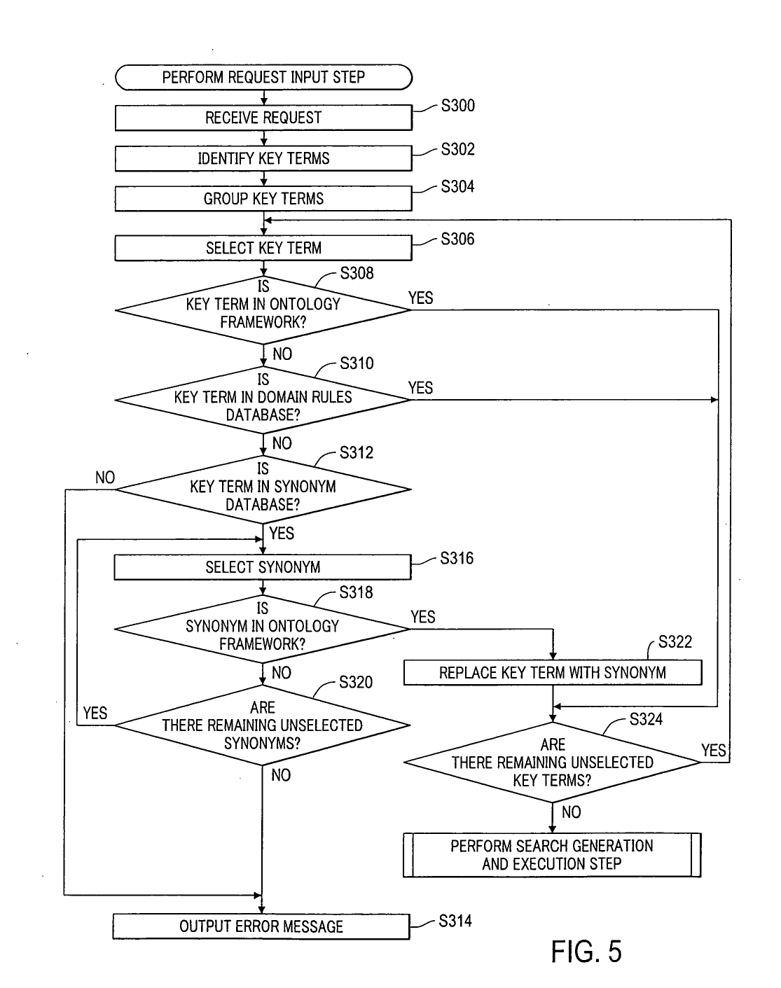

FIG. 5 illustrates the processing step 102 of FIG. 3. Processing the user's request may begin at step 300 where the user's request is received by the request parsing device 26 from the interface module 12. For embodiments in which the interface module 12 is omitted, the request parsing device 26 may receive the user's request directly from the user 20.

After the user's request is received by the request parsing device 26, the parsing device 24 may identify the key terms of the user's request (step 302). The key terms may be the terms of the user's request used by the search managing device 28 to fulfill the user's request. Such key terms may be the terms contained within the user's request that may be more than mere filler and may facilitate the retrieval of the requested information.

Next, the request parsing device 26 may substitute one or more key terms to facilitate retrieving the requested information (step 304). The substitution of key terms may be based on the format of the user's request or any other factor. For example, the request parsing device 26 may know that a user request in the form of a question that begins with the term “where” may be requesting a location. Accordingly, for the exemplary request, “where is my stuff?” the request parsing device 26 may substitute the term “where” with the term “location” to facilitate retrieving information identifying the location.

Next, the request parsing device 26 may form one or more key term groups (step 306). Each key term group may be formed to retrieve intermediate information or the information desired by the user 20. The intermediate information may be information that may need to be determined before the information requested by the user 20 can be retrieved. In addition, each key term group may include two key terms and an unknown relationship forming a bridge between the two key terms. Once the one or more key term groups are formed, a key term may be selected from the user's request (step 308), and the ontology framework 30 may be searched to determine whether the selected key term is in the ontology framework 30 (step 310).

If the selected term is not in the ontology framework 30 (step 310: no), the domain rules database 32 may be searched (step 312). If the selected key term is not in the domain rules database 32 (step 312: no), the synonym database 34 may be searched (step 314). If the key term is not in the synonym database 34 (step 314: no), the ROS 10 may output an error message to the user 20 (step 316). The error message may indicate that the ROS 10 does not understand the term. To correct the error, the user 20 may take any number of corrective measures such as, for example, manually entering the term into the ontology framework 30, domain rules database 32 or synonym database 34; correcting the spelling of the term; or abandoning the request for information altogether.

If the selected key term is in the synonym database 34 (step 314: yes), a synonym of the key term may be selected (step 318), and the ontology framework 30 may be searched to determine whether the selected synonym is in the ontology framework 30 (step 320). If the selected synonym is not in the ontology framework 30 (step 320: no), it may be determined whether there is another synonym in the synonym database 34 for the selected key term that has not yet been selected (step 322). If there are no more remaining unselected synonyms for the selected key term (step 322: no), then step 316 may be performed (i.e., the ROS 10 may output an error message to the user 20).

However, if there is a remaining unselected synonym for the selected key term (step 322: yes), a previously unselected synonym for the key term may be selected (step 318), and step 320 may be performed (i.e., the ontology framework 30 may be searched to determine whether the selected synonym is in the ontology framework 30).

Once a synonym for the key term is found in the ontology framework 30 (step 320: yes), the key term may be replaced with the synonym (step 324). After the key term is replaced with the synonym or if the key term is found in the ontology framework 30 (step 310: yes) or if the key term is found in the domain rules database 32 (step 312: yes), it may be determined whether there are any remaining unselected key terms in the user's request (step 326). If there are remaining unselected key terms in the user's request (step 326: yes), step 308 may be repeated (i.e., one of the previously unselected key terms may be selected). If there are no remaining unselected key terms in the user's request (step 326: no), the search managing device 28 may generate and execute a search strategy (step 328).

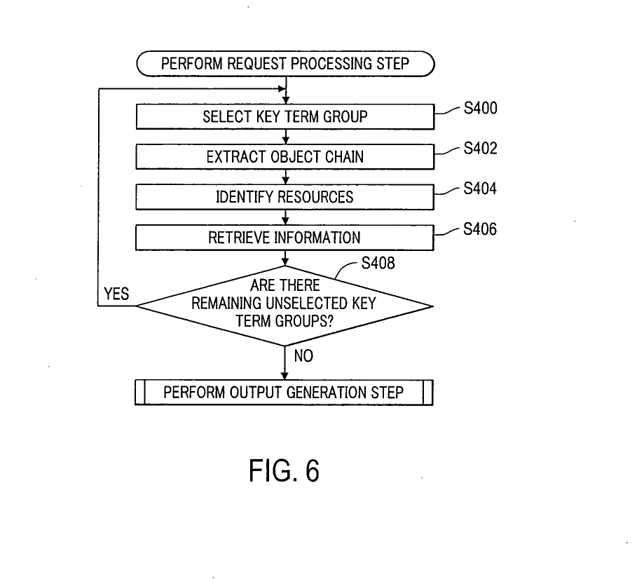

FIG. 6 illustrates the search strategy generation and search execution step 104 of FIG. 3. As illustrated in FIG. 6, one of the key term groups may be selected to build an object chain that may retrieve information (step 400). If there are one or more key term groups formed to retrieve intermediate information, those key term groups may be selected prior to the selection of the key term groups formed retrieve information requested by the user 20.

After a key term group is selected, an object chain may be extracted from the ontology framework 30 (step 402). The object chain may replace the unknown relationship of the selected key term group and may form a bridge between the two key terms of the selected key term group. Each link in the object chain may include two objects and a known relationship between the two objects. Each object in the object chain may be a thing or a concept such as, for example, a user ID, a location, etc. In addition, each object may be associated with a resource, and the relationship between the objects may facilitate retrieval of relevant information from the resource. For example, a link in the object chain may include an object “user ID” and an object “social security number.” The relationship between the two objects may be “user ID has social security number.” Additionally, the user ID and the social security number may be associated with the user semantic database 36. Accordingly, this particular link may direct the search managing device 28 to the user semantic database 36 to retrieve a user ID associated with a known social security number or retrieve a social security number associated with a known user ID.

The first link in the object chain may include one of the key terms of the selected key term group, and the last link in the object chain may include the other key term from the selected key term group that is not in the first link. In addition, each subsequent link in the chain may share an object with the previous link. For example, a link may include the objects “user ID” and “social security number,” and a subsequent link may include the objects “social security number” and “requisition.” As a result, information retrieved by the search managing device 28 in accordance with a link may be used by the search managing device 28 in accordance with a subsequent link to retrieve additional information. For example, a link including the objects “user ID” and “social security number” and the relationship “user ID has social security number”, may direct the search managing device 28 to retrieve the social security number “123456789”. A subsequent link may include the objects “social security number” and “requisition” and the relationship “requisition made by social security number”. The object “requisition” may be associated with a resource that may contain a plurality of requisitions. However, because the social security number may be known from the information retrieved in accordance with the first link, the subsequent link may direct the search managing device 28 to retrieve only requisitions made by “123456789”.

Next in step 404, each resource associated with an object in the extracted object chain may be identified. After all of the resources have been identified, the search managing device 28 may execute the search and may retrieve the information for which the key term group was formed (i.e., intermediate information or information requested by the user 20) (step 406). The search may begin with the retrieval of information in accordance with the first link that may include one of the key terms of the key term group. After the information associated with the first link has been retrieved, the search managing device 28 may retrieve additional information in accordance with the next link in the object chain. This process may be repeated until information is retrieved in accordance with the last link in the object chain that may include the other key term of the key term group not included in the first link. It should be understood that the information retrieved in accordance with the last link may be the information for which the key term group was formed (i.e., intermediate information or information requested by the user 20).

Thus, a search strategy may be dynamically generated in response to a user's request. In particular, an object chain tailored to the user's request may be extracted from the ontology framework 30 and may provide guidance to the search managing device 28 regarding which resource to query and what information contained within the resource may be retrieved to fulfill the user's request. Because the resources may be dynamically orchestrated, and not orchestrated according to a preset strategy, the flexibility of the system may be increased without increasing the amount of time and labor needed to perform the search for information.

After the search has been executed and the information for which the selected key term group was formed has been retrieved, the search managing device 28 may determine whether there are remaining unselected key term groups (step 408). If there are remaining unselected key term groups (step 408: yes), step 400 may be repeated (i.e., one of the previously unselected key term groups may be selected). If there or no remaining unselected key term groups (step 408: no), the output module 18 may generate an output.

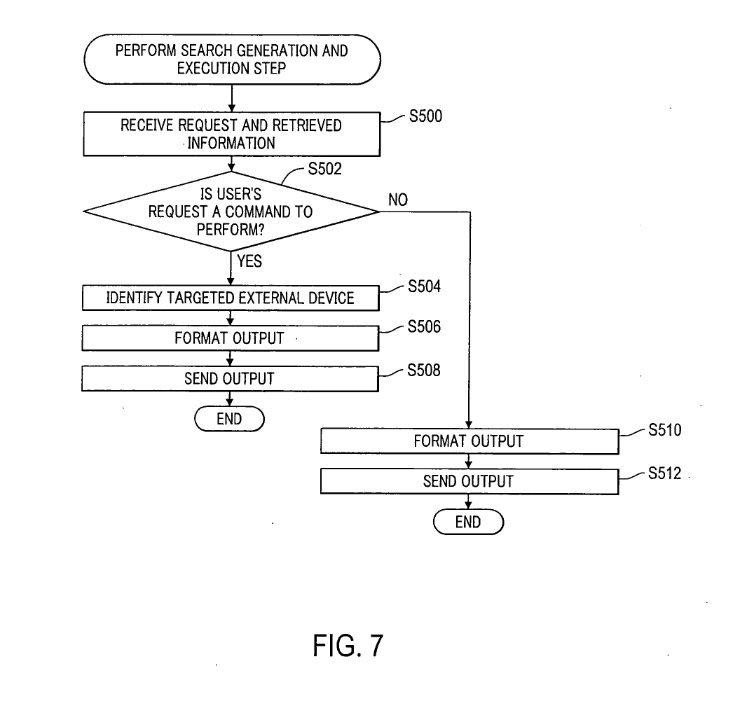

FIG. 7 illustrates the output generation step 106 of FIG. 3. As illustrated in FIG. 7, the output module 18 may receive the user's request and the retrieved information from the search module 14 (step 500). Next, the output module 18 may determine whether the user's request is a command to perform or a request for information (step 502). The determination may be made based on predetermined key terms, the format of the user's request or any other factor that may identify the user's request as a command to perform or a request for information. For example, a request in the form of a question may be a request for information and a request not in the form of a question may be a command to perform. In addition, the terms “who”, “what”, and “where” may indicate that the user's request is a request for information.

If the user's request is a command to perform (step 502: yes), the output module 18 may determine which external device 38 is being commanded to perform (step 504). For example, the command “Ship 50 shovels to store locations where snow is in the weather forecast,” may be directed to a warehouse logistics system. The output module 18 may determine which external device 38 may be the target of the command based on key terms included in the user's request (e.g., the term “ship” may indicate that the target of the command is a warehouse logistics system). Alternatively, the output module 18 may determine which external device 38 is the target of the command to perform based on information provided by the user 20 (e.g., the user 20 may input the identity of an external device 38 when the request is inputted into the interface module 12).

After, the targeted external device 38 is identified, the retrieved data may be modified to be in a format understandable by the targeted external device 38 (step 506). For example, the data retrieved for user request “Ship 50 shovels to the store locations where snow is forecasted” may be “it is forecasted to snow in Buffalo, N.Y.” The output module may modify the retrieved data to be in the form of a command (i.e., Ship 50 shovels to all store locations in Buffalo, N.Y.). In addition, the retrieved data may be modified to be in a form understandable by the targeted external device 38. The modification may be the language of the command (e.g., computer language, German, English, etc.). After the command is modified, the command may be transmitted to the targeted external device 38 (step 508) and the method may be terminated.

If the user's request is a request for information (step 502: no), the output module 18 may modify the retrieved data to be in a format understandable by the user 20 (step 510). For example, the data retrieved for user request, “Where is my stuff” may be “Buffalo, N.Y.” The output module may modify the retrieved data to be in a form understandable by the user 20. For the exemplary user request, the retrieved data may be modified to be “Your boots are in Buffalo, N.Y.” After the retrieved data is modified, the retrieved data may be transmitted to the user 20 (step 512) and the method may be terminated.

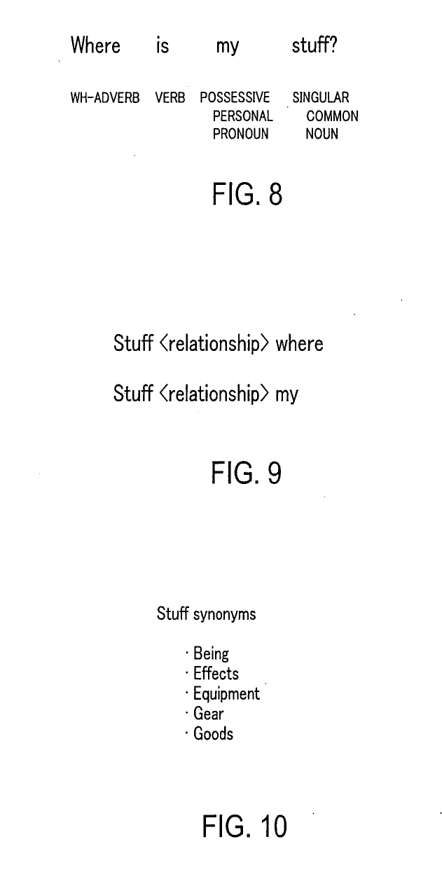

FIGS. 8-16 illustrate a fulfillment of an exemplary request for information, “Where is my stuff?” entered into the interface module 12 by a user named John Smith. Because “Where is my stuff” may be in a natural language format, the request processing device 22 may modify the user's request to be compatible with the search module 14. For example, as illustrated in FIG. 8, the request processing device 22 may associate each term in the request with a part of speech. The parts of speech may help the search module 14 determine the focus of John Smith's request and the role of each term in John Smith's request and.

After being modified, the user's request may be transmitted to the request parsing device 26 of the search module 14. The request parsing device 26 may determine that the wh-adverb, the personal pronoun and the singular common noun may be the key terms of the user's request. Accordingly, the request parsing device 26 may parse out the terms “stuff,” “where,” and “my” from the user's request. In addition, the request parsing device 26 may know that user requests in the form of a question beginning with the term “where” may be requesting a location. Thus, the request parsing device 26 may substitute the term “where” with the term “location” to facilitate determining the location of the “stuff”.

Next, as can be seen in FIG. 9, the request parsing device 26 may group the key terms based on the information needed to be retrieved to fulfill the user's request. For example, to fulfill the exemplary user's request, the location of the stuff may be determined. This information may be the information requested by the user 20. However, to determine the location of the stuff, it may need to be determined what “my stuff” is. This information may be intermediate information.

Accordingly, the request parsing device 26 may form two key term groups. The first key term group, “stuff <relationship> location,” may be formed to retrieve information requested by the user 20. The second key term group, “stuff <relationship> my,” may be formed to retrieve intermediate information. The key term groups may be created using a collection of triples that may include two key terms and an unknown relationship between the two key terms. It is contemplated that the key terms may be grouped using another format as long as the format indicates that there may be an unknown relationship between the two key terms.

Once the key terms are grouped into key term groups, the ontology framework 30 may be searched to determine if the key terms are in the ontology framework 30. In this case, “location” and “my” may be in the ontology framework 30 but “stuff” may not. In addition, “stuff” may not be in the domain rules database 32. However, as illustrated in FIG. 10, the synonym database 34 may include several synonyms for “stuff” (i.e., being, effects, equipment, gear and goods). Going down the list, “being” and “effects” might not be in the ontology framework 30 but “equipment” may be in the ontology framework 30. Once a synonym is found in the ontology framework 30, the search managing device 28 may replace the key term with the synonym. The resulting key term groups may include “equipment <relationship> location” and “equipment <relationship> my”.

To generate a search strategy, the search managing device 28 may extract an object chain from the ontology framework 30 that may link the key terms included in a selected key term group. The object chain may include a plurality of links. In addition, each link may include two objects connected to each other via a known relationship. Also, each link may share an object with a preceding link and may share another object with a subsequent link. Furthermore, the first link in the object chain may include on of the key terms in selected key term group, and the last link in the object chain may include the other key term in the selected key term group not in the first link of the object chain.

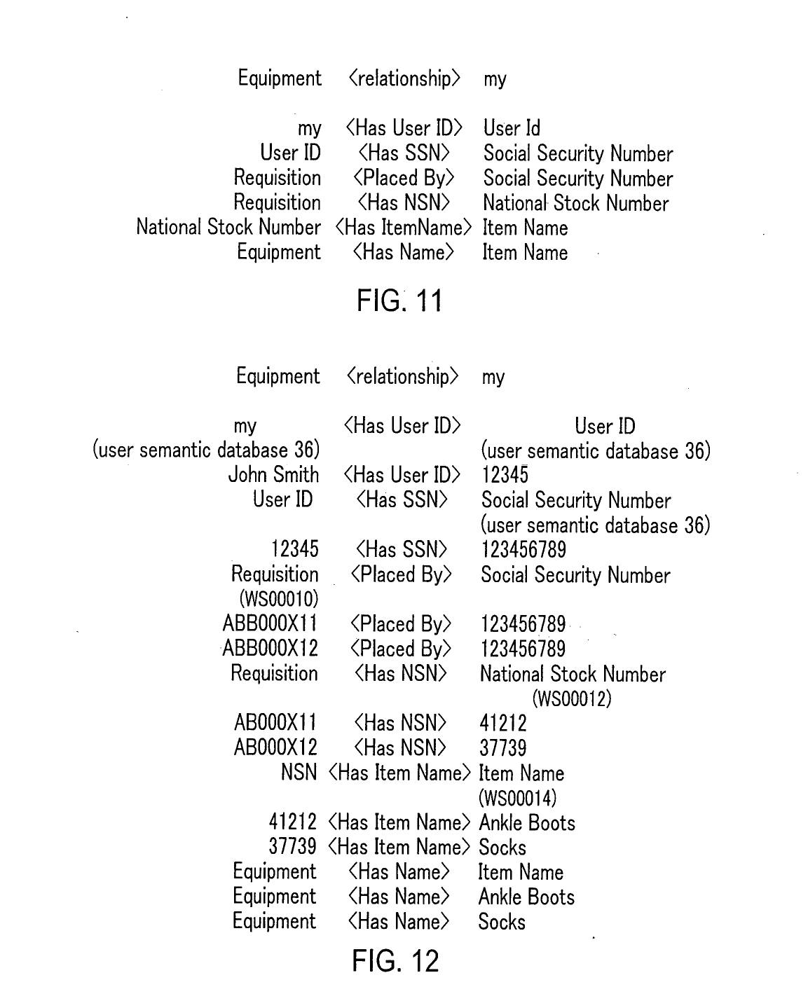

As illustrated in FIG. 11, the key term group, “equipment <relationship> my,” may be selected before the key term group, “equipment <relationship> location,” because the key term group “equipment <relationship> my,” may be formed to retrieve intermediate information, while the key term group, “equipment <relationship> location,” may be formed to retrieve information requested by the user 20. In addition, the first link in the extracted object chain may include the key term “my”, and the last link in the extracted object chain may include the key term “equipment”. Furthermore, each link in the object chain may share an object with a preceding link and may share another object with a subsequent link. Thus, the links extracted from the ontology framework 30 may form an object chain that may form a bridge between the key terms of the key term group, “Equipment <relationship> my.”

As illustrated in FIG. 12, each object may be associated with a resource. For example, “UserID”, “social security number”, and “my” may be associated with user semantic database 36. In addition, “requisition” may be associated with web service “WS00010”, “national stock number” may be associated with web service “WS00012”, and “item name” may be associated with the web service “WS00014”. When executing a search, the search managing device 28 may reference each link sequentially, starting at the first link. When referencing the first link, the key term “my” may direct the search managing device 28 to the user semantic database 36, which may include the name “John Smith” associated with the term “my”. The object “userID” may also direct the search generating device 28 to the user semantic database 36. The combination of “my” and the known relationship “<HasUserID>” may indicate which userID to retrieve from the user semantic database 36. In this case, the userID for John Smith may be “12345”. Thus, for each link, one object may direct the search generating device to a resource, and the combination of the other object and the known relationship may indicate which information may be retrieved by the search generating device 28.

By referencing each link sequentially, the search generating device 28 may retrieve information that may be used to retrieve additional information that may eventually lead to the retrieval of information for which the selected key term group was formed to retrieve. For example, The userID, 12345, may be used to retrieve the social security number, 123456789, from the user semantic database 36. The social security number, 123456789, may be used to retrieve requisition numbers, AB000X11 and AB000X11 from web service WS00010. Requisition numbers AB000X11 and AB000X11 may be used to retrieve national stock numbers 41212 and 37739 from web service WS00012. National stock numbers 41212 and 37739 may be used to retrieve item names “ankle boots” and “socks” from web service WS00014. For the last link, the key term “equipment” may not be associated with any resource. Instead, the key term “equipment” may be associated with the items names “ankle boots” and “socks”, thereby retrieving the intermediate information for which the selected key term group “my <relationship> equipment” was formed.

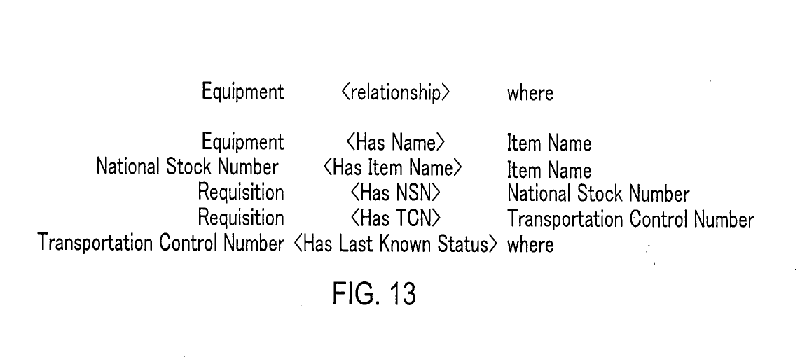

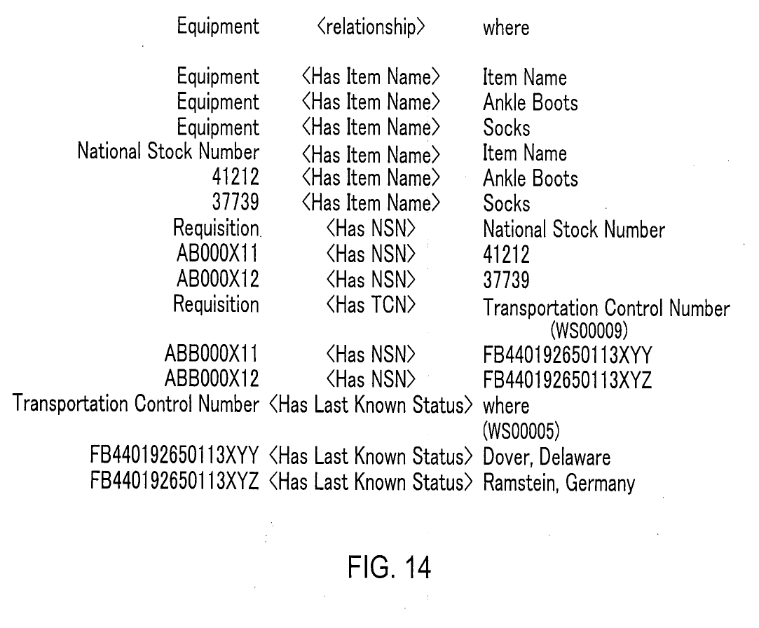

FIG. 13 illustrates an object chain extracted for the key term group “equipment <relationship> location.” Information associated with the objects “item name”, “national stock number” and requisition may already be known from the search illustrated in FIG. 12. Therefore, the search generating device 28 may not need to be directed to the resources associated with those objects. However, the search generating device 28 may need to access the references associated with newly extracted objects “transportation control number” and “location”. As can be seen in FIG. 14, “transportation control number” may be associated with web service WS00009, and “where” may be associated with the web service WS00005.

For the object chain illustrated in FIG. 14, the item name for equipment may already be known from the previous search. Thus, the item names “ankle boots” and “socks” may be used to retrieve the national stock number. However, the national stock numbers for ankle boots and socks may already be known from the previous search. Therefore, WS00012 may not need to be accessed. In addition, the requisition numbers for national stock numbers 41212 and 37739 may be known from the previous search. Thus, WS00010 may not nee to be accessed. The requisition numbers may be used to retrieve the previously unknown transportation control numbers from the web service WS00009. In addition, the transportation control numbers may be used to retrieve the locations of the equipment from the web service WS00005. The search may end when information indicating that transportation control number FB440192650113XYY is located in Dover, Del. and transportation control number FB440192650113XYZ is located in Ramstein, Germany. This information may be the information requested by the user 20.

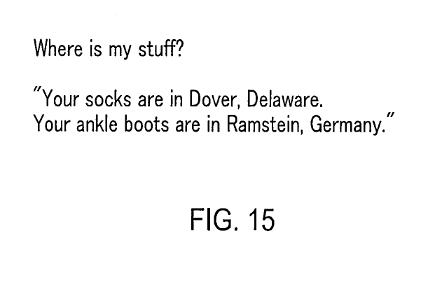

After the requested data has been retrieved, the data and the user request may be transmitted to the output module 18, where the reply to the user's request may be formatted. In this case, as illustrated in FIG. 15, the output may be put in a natural language format understandable by the user (i.e., Your socks are in Dover, Del. Your ankle boots are in Ramstein, Germany).

While the above-disclosed methods and systems have been described in conjunction with the specific exemplary embodiments thereof, it is evident that many alternatives, modifications, and variations will be apparent to those skilled in the art. Accordingly, exemplary embodiments of the above-disclosed methods and systems as set forth herein are intended to be illustrative, not limiting. There are changes that may be made without departing from the spirit and scope of the above-disclosed methods and systems.

What is claimed is:

1. A resource coordinating system, comprising:
an interface module that receives a request from a user;
an ontology framework module including a plurality of objects, each object being associated with a respective resource;
a search module that coordinates a retrieval of information from one or more resources based on a search strategy generated in response to the user's request;
an output module that generates an output to the user based on the retrieved information,
wherein, the search strategy selects objects from the ontology framework module based on the user's request and each selected object directs the search module to the associated resource.

2. The resource coordinating system of claim 1, wherein the ontology framework includes a plurality of pairs of objects connected by a known relationship.

3. The resource coordinating system of claim 2, wherein the search strategy is formed from a chain of object pairs.

4. The resource coordinating system of claim 3, wherein one object of an object pair directs the search module to a resource and the other object of an object pair identifies which information stored in the resource to retrieve.

5. The resource coordinating system of claim 2, wherein each object pair in the chain of object pairs shares an object with a preceding object pair in the object pair chain.

6. The resource coordinating system of claim 5, wherein each object pair in the chain of object pairs shares an object with a subsequent object pair of the object pair chain.

7. The resource coordinating system of claim 3, wherein the chain of object pairs includes portions of the user's request.

8. A method for retrieving information in response to a request from a user, comprising:
receiving the request from the user;
selecting a plurality of objects from an ontology framework based on the user's request;
accessing resources associated with the selected objects and retrieving data from the associated resources; and
generating an output in response to the retrieved data.

9. The method of claim 8, wherein the plurality of objects includes pairs of objects, the objects in the pair being connected to each other by a known relationship.

10. The method of claim 9, further including forming a chain of object pairs in response to the user's request.

11. The method of claim 10, wherein each object pair in the chain of object pairs shares an object with a preceding object pair.

12. The method of claim 11, wherein each object pair in the chain of object pairs shares an object with a subsequent object pair.

13. The method of claim 12, wherein the chain of object pairs includes portions of the user's request.

14. The method of claim 13, wherein each object pair directs a search module to an associated resource and identifies which information to retrieve from the associated resource.

15. A resource coordinating system, comprising:
an interface module that receives a request from a user;
an request processor that formats the user's request to be in a form compatible with the resource coordinating system;
an ontology framework module including a plurality of objects, each object being associated with a respective resource;
a search module that coordinates a retrieval of information from one or more resources based on a search strategy generated in response to the user's request; and
an output module that generates an output to the user based on the retrieved data, the output being at least one of a presentation of information, or a command to perform.

16. The resource coordinating system of claim 15, wherein the ontology framework includes a plurality of pairs of objects connected by a known relationship.

17. The resource coordinating system of claim 16, wherein the search strategy is formed from a chain of object pairs.

18. The resource coordinating system of claim 17, wherein one object of an object pair directs the search module to a resource and the other object of an object pair identifies which information stored in the resource to retrieve.

19. The resource coordinating system of claim 16, wherein each object pair in the chain of object pairs shares an object with a preceding object pair in the object pair chain.

20. The resource coordinating system of claim 19, wherein each object pair in the chain of object pairs shares an object with a subsequent object pair of the object pair chain.
